(19) United States
(12) Patent Application Publication
(10) Pub. No.: US 2006/0029016 A1
(43) Pub. Date: Feb. 9, 2006

(54) Debugging application performance over a network

(75) Inventor: Amir Peles, Tel Aviv (IL)

Correspondence Address: KATTEN MUCHIN ROSENMAN LLP, 575 MADISON AVENUE, NEW YORK, NY, 10022-2585, US

(73) Assignee: RADWARE LIMITED

(21) Appl. No.: 11/158,888

(22) Filed: Jun. 22, 2005

Related U.S. Application Data
(60) Provisional application No. 60/584,253, filed on Jun. 29, 2004.

(51) Int. Cl. H04Q 7/00

(52) U.S. Cl. 370/328

(57) ABSTRACT

An application debugging switch also monitors application performance. The application debugging switch forwards the requests from a first host to a second host, and later forwards the response coming from that second host to that first host. As most of the applications work in a request—response architecture, the application debugging switch can measure the response time of the application. The switch attaches a timestamp to each request that it forwards. When the response to that request comes to the switch, the switch can determine the response time of that application. The application debugging switch collects multiple samples of response time over a certain period of time. These samples provide a good measurement for the average application response time. The response time is a combination of the network response time and the application response time. The application debugging switch holds multiple measurement classes. Each class defines different sources or destinations of traffic (IP addresses and networks) and different applications (TCP/UDP ports or content identifiers in the requests). Collecting the response time for each class separately allows zooming in to an application and user that experience bad service and detect the reason for their failure.

### PRIORITY INFORMATION

This application claims the benefit of U.S. Provisional Application No. 60/584,253, filed Jun. 29, 2004, herein incorporated by reference.

### BACKGROUND OF THE INVENTION

1. Field of Invention

The present invention relates generally to the field of monitoring computer networks. More specifically, the present invention is related to monitoring network response time and the application response time.

2. Discussion of Prior Art

Computer networks today are growing fast and becoming the main media for communications inside organizations and between users world wide. Network speeds are also growing and the network today can serve more content (images, audio, video) in good quality. All in all, the network is currently evolving to be a platform for many services and applications—from the basic services of e-mail and browsing information on the network, through the online shopping and trading, until games, voice and video services. Each service demands a minimal level of network resources in order to function efficiently and reliably.

The growth of the network brings many challenges. The global Internet is actually a collection of multiple networks of multiple providers, some are public and some are private. Each provider can efficiently handle different traffic capacity and gives a different quality of service. The capacity and quality are changing during the day and depend on the traffic that users generate. These networks are interconnected through routers in different peering points, which offers many options for passing traffic between any two endpoints connected to the network. Another big challenge is security. To protect the private networks that connect to the Internet special security equipment is installed like firewalls, anti-viruses, encryption devices. Each of the devices that traffic passes through may introduce latency to the forwarding of packets and may become a point of failure.

Network administrators and service operators are constantly monitoring the network. Whenever a failure happens, the administrator looks to find the point of failure in the network. The process of maintaining the networks and fixing failures involves three steps—learning that a problem exists, locating the source of the problem and fixing the problem.

A failure can be a physical failure of a device, like a power failure or a network cable disconnection, or it can be an application failure like a failed process or misconfiguration. The failure can occur on the service side, so all the users will not be served properly, or the failure can occur on the user side that will not be served properly, or the failure can occur somewhere on the path between the servers and the users, making some of the users suffer while others are working.

A failure can also be a partial failure. Computer equipment may be performing slow due to several conditions like overload or misconfiguration. In this case the failure can be very hard to detect as part of the users are lucky to receive good service, part of them experience slow service and some of them will not get service at all.

Monitoring networks involves many existing techniques. One technique uses network management stations that monitor the status of the routers and other networking equipment. These stations collect statistics about the equipment responsiveness, its CPU load and networking load and can recognize failures of the equipment. This technique is limited, as it doesn't reflect any service level parameter, but only the health of the networking equipment.

A second technique involves agents that are installed on network equipment, communicating with each other, mapping the operation of the network and the response time between different points in the network. This technique is limited as the testing of the network involves synthesized test traffic that is not representing any relevance to the actual applications that users are operating, so it only represents network performance and not application performance.

A third technique uses active user machines spread across the network that generate application request and report about the performance experienced from the multiple end-points. These measurements reflect the actual user experience and allow testing the user experience under stress. The technology is limited as the testing uses generated traffic and doesn't reflect the actual experience of real users exercising real transactions.

A fourth technique uses passive monitoring equipment that receives a copy of the traffic from the real network near the service center and can monitor the actual user transactions and monitor the service level they experience to trigger on any failure. This technique is limited as the measurements are only effective to detect the failure, but can't help in locating the source of the failure or fixing it.

Most applications on the web are using multiple protocols and multiple connections in order to communicate between a client and a server. Usually a host sends a first DNS request in order to locate the address of a second host or a server, and then starts sending application communication, using TCP or UDP as an underlying protocol to the actual application protocol. Failures, delays and malfunctions can occur on each level of these communication protocols.

The following patents provide a general description of network probes, which copy incoming data so that they can analyze such data, but they fail to provide for a solution whereby response times are calculated at a finer granularity without copying data.

The patent application to Curley, et al. (2002/0120727), provides for a Method and Apparatus for Providing Measurement, and Utilization of, Network Latency in Transaction-Based Protocols. According to Curley et al., network monitors 16 are located in a distributed fashion at various nodes or other geographical presence points of network 12. Network monitors 16 monitor network communications between server 14 and client 10. Network monitors 16 can listen to network 12 to detect requests for web pages or other information from client to server 14 and may monitor response provided by server to client. Network monitor measures network latency by measuring the round trip time between TCP transports of client and server.

The Japanese patent to Bardick, et al. (JP11346238), provides for a Response Time Measurement System. According to Badick et al., a plurality of probes inserted in various positions in a network decide the response time at these positions, which determines a place in the network where a delay of data transmission is caused.

Whatever the precise merits, features, and advantages of the above cited references, none of them achieves or fulfills the purposes of the present invention.

### SUMMARY OF THE INVENTION

The current invention offers a solution to actively detect performance problems, locate the potential source of the problem and assist in fixing and bypassing the failure. The invention includes active networking equipment called application debugging switch and a central monitoring station called Debugging Center.

The application debugging switches are installed in multiple points in the network. The switches offer multiple functionalities. These are forwarding traffic, distributing traffic inside clusters of resources, gathering statistics, monitoring application health and monitoring application performance. The switches also communicate with the debugging center to report about the local status and receive further commands.

The first functionality is forwarding of traffic. The switch receives packets from the network, takes forwarding decisions according to any information in the packet and transmits the packet toward its target. The forwarding logic uses forwarding rules that define the target for each packet. The rules involve networking characteristic of the traffic like the physical access port where the packet was received, the logical MAC addresses (source and/or destination) of the packet, IP addresses of the packet, TCP/UDP ports and actually any parameter in the traffic headers or the content of the traffic. In general, having two hosts on the network communicate through the switch, the switch receives a packet coming from the first host and transmits it towards the second host. It later receives a response packet from the second host and transmits it towards the first host. A session can have any number of packets coming from one host to the other. There are also cases where traffic will flow through the switch multiple times. If the switch connects to a gateway like a security device then it will first receive the traffic from the first host and will transmit it toward the security device for inspection. That traffic is coming back from the security device to the switch after inspection. Then, the switch transmits the traffic toward the second host. When the response returns from the second host the switch forwards the response to the security gateway. When the response comes back from the gateway the switch forwards the request to the first host. There can be an unlimited number of gateways that traffic goes through while it passes back and forth through the switch. According to the forwarding rules it's possible that traffic of one application between two hosts goes between them directly through the switch, while traffic of another application passes through the security gateway and only then the switch transmits it forward. Part of forwarding the packet is also modifying some of the packet header fields like L2, L3 or L4 addresses. For some types of traffic the application debugging switch can also copy the traffic to an external device for collecting or analyzing.

The second functionality is the distribution of traffic inside clusters of resources. Due to problems like failures and overloading, administrators are duplicating applications such that there is no single point of failure in the network and each application can scale over an unlimited number of resources. The application debugging switch offers the option to use clusters of resources as the target of its forwarding rules. Once a new session arrives at the switch and the forwarding rule points to a cluster of resources, the switch selects one of the available resources in the cluster and forwards the traffic through this resource. There are multiple algorithms that the switch uses to select the resource, based on the resource availability, load, pricing, proximity and performance. The switch makes sure that it transmits the following packets of the session through the same resource for persistence. One way to do it is keeping the decision in memory such that the following packets of that session are recognized and the switch transmits them to the same resource. The distribution decision effects the modifications of the packet as the switch modifies the packet differently in order to imply the distribution decision and to enforce the forwarding to a specific resource. Examples of modification are setting of the destination MAC address or the destination IP address before sending the packet to that destination. When debugging the operation and service of the application, the application debugging switch can select a single resource of a cluster and send traffic only to this resource in order to debug it. Another option is to forward test traffic through a single resource for debugging while sending the rest of the regular traffic to other resources such that the application continues to work smoothly.

The third functionality is the gathering of statistics about the application usage and the resources activity. The switch carries policies that define different classes of traffic by any L1-L7 classification parameter, similar to the forwarding rule parameters. Each session is matched to the policies, and when a match occurs, the switch counts the number of sessions, packets and bytes that passed through the system and fit to each policy. The counters can be reset every second or any other time period so they also measure the rate of traffic and not just the total traffic. When forwarding to clusters, the switch keeps the same counters separately for each of the clustered resources and counts the amount of traffic that came from the resource and the amount of traffic that the switch transmitted to each resource, as well as the numbers of connected users. The information about application usage determines the peak times of application usage and dictates activation of backup resources whenever the application usage goes over a threshold. The administrator of the system can provide the threshold manually. The application debugging switch also monitors the number of retransmitted packets going through each resource. The retransmitted packets imply that packets are lost. When packet loss goes over a threshold the application debugging switch operates more resources to distribute the load. The information about the statistics passes to the debugging center that prepares graphs of application and network usage, comparing different times or different policies.

The fourth functionality is the monitoring of applications health. The application debugging switch continuously checks the applications in the network, simulating user traffic and accessing internal resources to make sure that the application is available for users and that it functions as expected. Checks range from verifying physical electric connectivity, accessing the IP stack, opening sockets on the TCP stack or accessing the UDP listener on the generic application level, and go deeper to the application by simulating a user's transaction and verifying the information of the response. Health checks can monitor complementary services like databases and authentication servers that can be linked to the actual applications that depend on these services. Health status of the various resources passes to the debugging center. The debugging center gathers health information from multiple application debugging switches and correlates them with other information such as usage statistics. If failures are correlated with high usage the debugging center identifies lack of resources and recommends on adding new resources where needed.

The fifth functionality is the monitoring of application performance. The application debugging switch forwards the requests from a first host to a second host, and later forwards the response coming from that second host to that first host. As most of the applications work in a request—response architecture, the application debugging switch can measure the response time of the application. The switch attaches a timestamp to each request that it forwards. When the response to that request comes to the switch, the switch can determine the response time of that application. The application debugging switch collects multiple samples of response time over a certain period of time. These samples provide a good measurement for the average application response time. The response time is a combination of the network response time and the application response time. Therefore, different users in different locations on the network experience different response time based on the functionality and quality of the network. On the other end, the same user may experience different response time when accessing two different applications. The application debugging switch holds multiple measurement classes. Each class defines different sources or destinations of traffic (IP addresses and networks) and different applications (TCP/UDP ports or content identifiers in the requests). Collecting the response time for each class separately allows zooming in to an application and user that experience bad service and detect the reason for their failure. Together with the response time, the application debugging switch also calculates the rate of retransmitted packets and the rate of unsuccessful application requests. This provides information about the amount of packet loss in the network/application. Unsuccessful requests are not answered by the application or answered with an error response, so the switch can identify them. When each of the parameters for an application response time, retransmissions on the network or unsuccessful requests goes over a certain threshold the application debugging switch provides a notification for the debugging center. The debugging center gathers the statistics and offers analysis tools to try and zoom to the most specific definition of the problem (finding the slow server in a cluster, the slow user network of all users) by decreasing the scope of the policies and refining them. When detecting a problem the application debugging switch can take measures to solve the problem. The application debugging switch bypasses slow devices and failing devices when it takes its forwarding decision. The switch limits the throughput of low priority traffic and gives best priority to critical traffic.

As the applications are using multiple communication protocols, the application debugging switch can monitor each of these protocols in order to analyze the functionality of the application. The switch detects failures and delays and can point the administrator immediately to the bottleneck in its network.

A networking system can have multiple application debugging switches installed inside it. In this scenario, traffic between a first host and a second host flows through more than a single application debugging switch. The debugging center that collects all the monitoring information from the application debugging switches immediately maps the delays of application service on the network at multiple points. With this information, whenever a problem occurs the debugging center points to the point in the network, either the client machine, server machine or other machines on the network path between them that creates the delay and the problems in service.

While operating this networking system with application debugging switches, the administrator can also send some artificially generated traffic for the service in varying volumes. Bringing the volume of traffic higher and higher, the administrator can follow up on changes in the responsiveness of the application and identify potential bottle necks in the whole system.

In one embodiment, the present invention's method monitors response times associated with client(s) and server(s) located in a network (e.g., LAN, WAN, or the Internet), wherein the method is implemented in an application debugging switch (among a plurality of the application debugging switches dispersed over the network). In this embodiment, the method comprises the steps of: (a) receiving a request (such as, but not limited to, a request via any of the following protocols: TCP/IP, HTTP, DNS, SSL, IMAP, POP3, SMTP, FTP, RTSP, SIP, H.323, NFS, NNTP, LDAP, or RADIUS) from a client intended for a server and identifying and storing a timestamp t1 when the request is received; (b) forwarding the request to the server; and (c) receiving a response from the server and identifying and storing timestamp t2 when the response is received, and (d) calculating a server response time as a difference between t2 and t1, wherein the calculated server response time quantifies network and application bottlenecks in the network and server, respectively. In an extended embodiment, the present invention's method comprises the additional steps of: (e) forwarding the response to the client and storing timestamp t3 when the response is forwarded; (f) receiving an acknowledgement from the client, storing timestamp t4 when the response is received, and (g) calculating a client response time as a difference between t4 and t3, wherein the calculated client response time quantifies the quality of the network between the application debugging switch and the client.

In another embodiment, the method of the present invention, as implemented in an application debugging switch, identifies bottlenecks associated with a server based on monitoring network and application response times associated with the server. In this embodiment, the method comprises the steps of: (a) transmitting a plurality of requests to the server and monitoring network and application response times, the plurality of requests targeting a combination of any of the following: a communication protocol stack supported by the server, application logic of the server, storage resources of the server, operating system resources of the server, or CPU resources of the server; (b) storing timestamps associated with the plurality of transmitted requests; (c) receiving a plurality of responses from the server, identifying and storing a timestamp for each received response; (d) calculating server response time for each received response as a difference between timestamp of each received response and a timestamp associated with a corresponding transmitted request; and (e) identifying network and application responsiveness associated with the server based on the calculated server response times.

In one embodiment, the present invention provides for a networking system comprising: (a) a plurality of application debugging switches dispersed throughout a network, each application debugging switch: transmitting a plurality of requests to a server to monitor network and application response times, the plurality of requests targeting a combination of any of the following: a communication protocol stack supported by the server, application logic of the server, storage resources of the server, operating system resources of the server, or CPU resources of the server; storing timestamps associated with the plurality of transmitted requests; receiving a plurality of responses from the server, identifying and storing a timestamp for each received response, and calculating server response time for each received response as a difference between timestamp of each received response and a timestamp associated with a corresponding transmitted request, and (b) a debugging center collecting response time information from the plurality of application debugging switches and identifying network and application bottlenecks associated with servers in the network based on the collected response times.

In another embodiment, the present invention provides for a networking system comprising a plurality of application debugging switches dispersed throughout a network and a debugging center in communication with said debugging switches. Each application debugging switch transmits a request to a server and stores timestamp t1 when the response is forwarded, receives a response from the server and stores timestamp t2 when the response is received, and calculates a server response time as a difference between t2 and t1. The debugging center collects response time information from the plurality of application debugging switches and maps application and/or network delays.

In one embodiment, the present invention provides for a networking system comprising: (a) a plurality of application debugging switches dispersed throughout a network, each application debugging switch: receiving a request from a first host on the network intended for a second host on the network, identifying and storing a timestamp t1 when the request is received, forwarding the request to the second host, receiving a response from the second host, identifying and storing timestamp t2 when the response is received, and calculating a second host response time as a difference between t2 and t1, forwarding the response to the first host and storing timestamp t3 when the response is forwarded, receiving an acknowledgement from the first host, storing timestamp t4 when the response is received, and calculating a first host response time as a difference between t4 and t3, and (b) a debugging center collecting response time information from the plurality of application debugging switches and mapping application and network responsiveness.

The present invention also provides a method implemented in an application debugging switch to monitor response times in phases for application transactions between a client to a plurality of servers, plurality of the application debugging switches dispersed over a network, wherein the method comprising the steps of: (a) receiving a TCP connection request from the client and forwarding the TCP connection request to an application server at timestamp t1; (b) receiving a TCP acknowledgement message from the application server at timestamp t2, calculating a TCP response time as t2-t1, and forwarding the TCP acknowledgement message to the client; (c) receiving an application request from the client and forwarding the application request to the application server at timestamp t3; (d) receiving an application reply from the application server at timestamp t4, calculating a application response time as t4-t3, and forwarding the application reply to the client, and wherein the application debugging switch measures response time of each phase in a transaction to identify responsiveness in each phase of the transaction. In an extended embodiment, the present invention's method comprises the additional steps of: (e) receiving a DNS query from a DNS client and forwarding said DNS query to a DNS server at timestamp t5; (f) receiving a DNS response from said DNS server at timestamp t6, (g) calculating a DNS server response time as t6-t5, and (h) forwarding said DNS response to said DNS client.

In another embodiment, the networking system comprising: (a) at least one application debugging switch facilitating communication between one or more clients and at least one application server and collecting statistics comprising network response times and application response times associated with the server; (b) at least one policy logging server maintaining one or more policies defining mathematical operations on collected statistics, wherein the at least one application debugging switch performs mathematical operations on the collected statistics according to a predefined policy in the policy logging server; and wherein the collected statistics are used to map application and network delays. In an extended embodiment, the present invention's networking system comprises an additional: (c) at least one record logging server receiving collected statistics operated on according to a predefined policy in the at least one policy logging server,

In another embodiment, the present invention provides for a plurality of devices dispersed throughout a network, wherein each of the devices comprises: (a) a first network interface to transmit a plurality of requests to a server to monitor network and application response times, the plurality of requests targeting a combination of any of the following: a communication protocol stack supported by the server, application logic of the server, storage resources of the server, operating system resources of the server, or CPU resources of the server; (b) a first memory to store timestamps associated with the plurality of transmitted requests; (c) a second network interface to receive a plurality of responses from the server; (d) a second memory to store a timestamp for each received response; (e) a processor to calculate server response time for each received response as a difference between timestamp of each received response and a timestamp associated with a corresponding transmitted request, wherein a debugging center works in conjunction with each of the devices and collects response time information to identifying network and application bottlenecks associated with servers in the network.

In another embodiment, the present invention also provides for a method to monitor response times associated with client(s) and server(s) located in a network, wherein the method is implemented in at least two application debugging switches dispersed over the network. The method, in this embodiment, comprising the steps of: (a) receiving, at a first debugging switch, a request from a client intended for a server, said first application debugging switch: identifying a timestamp t11 when it receives said request, and forwarding said request to said server; (b) receiving, at a second debugging switch, said forwarded request, said second debugging switch identifying a timestamp t21 when it receives said forwarded request, forwarding said request to said server, receiving a response from said server, identifying a time stamp t22 when said response is received in said server, and forwarding said response to said client; (c) receiving said forwarded response at said first application debugging switch, said first application debugging switch: identifying a timestamp t12 when said forwarded response is received, and forwarding said response to said client. The first response time RT1 is calculated in the first debugging switch as the difference between response times t12 and t11 and a second response time RT2 is calculated at the second debugging switch as difference between response times t22 and t21, wherein the response times identifying network and application responsiveness. In an extended embodiment, the response times RT1 and RT2 are forwarded to a debugging center, wherein the debugging center calculating a response time RT as the difference between RT1 and RT2. The difference RT identifies network bottlenecks between said first and second debugging switch.

The present invention also provides for a networking system comprising: a traffic generation machine generating network traffic and a plurality of application debugging switches. In this embodiment, at least one application debugging switch: receives a plurality of requests generated by the traffic generation machine intended for a server on the network, identifies and stores timestamps when the requests are received; forwards the plurality of requests to the server; receives a plurality of responses corresponding to the plurality of requests from the server, identifies and stores timestamps when the responses are received and calculates response times as a difference between the time stamp when a request is received and the time stamp when a response is sent, wherein the at least one application debugging switch in conjunction with the traffic generation machine increases the generated traffic intended for the server, calculates response time for the generated traffic, and identifies the amount of traffic when a failure threshold is reached.

### BRIEF DESCRIPTION OF THE DRAWINGS

FIG. 1A describes an application environment according to the present invention.

FIG. 1B describes an example of a possible traffic flow in an application site.

FIG. 2A describes a set of forwarding policies in the application debugging switch.

FIG. 2B describes the actual forwarding of traffic between a client and a server.

FIG. 2C describes another example for traffic forwarding.

FIG. 2D describes yet another example for actual forwarding of traffic between a client and a server.

FIG. 3A describes the health checking aspect of the present invention.

FIG. 3B describes the health checking of a path.

FIG. 4A describes a load balancing decision.

FIG. 4B describes a debugging system according to the present invention.

FIG. 5A describes a policy statistic table according to the present invention.

FIG. 5B describes a policy threshold table according to the present invention.

FIGS. 6A-C describe the measurement of response time according to the present invention.

FIGS. 7A-B describe how packet loss is handled by the application debugging switch.

FIG. 8A describes a successful TCP transaction.

FIG. 8B describes an unsuccessful TCP transaction.

FIG. 9A describes the topology for using the application debugging switch for logging the network activity.

FIG. 9B describes a policy logging report from the application debugging switch to a policy logging server.

FIG. 9C describes a record logging report for two sessions.

FIG. 10 describes a configuration that uses multiple application debugging switches on the path between a client and a server.

FIG. 11 describes a combination of operating the application debugging switch and a traffic generation machine.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

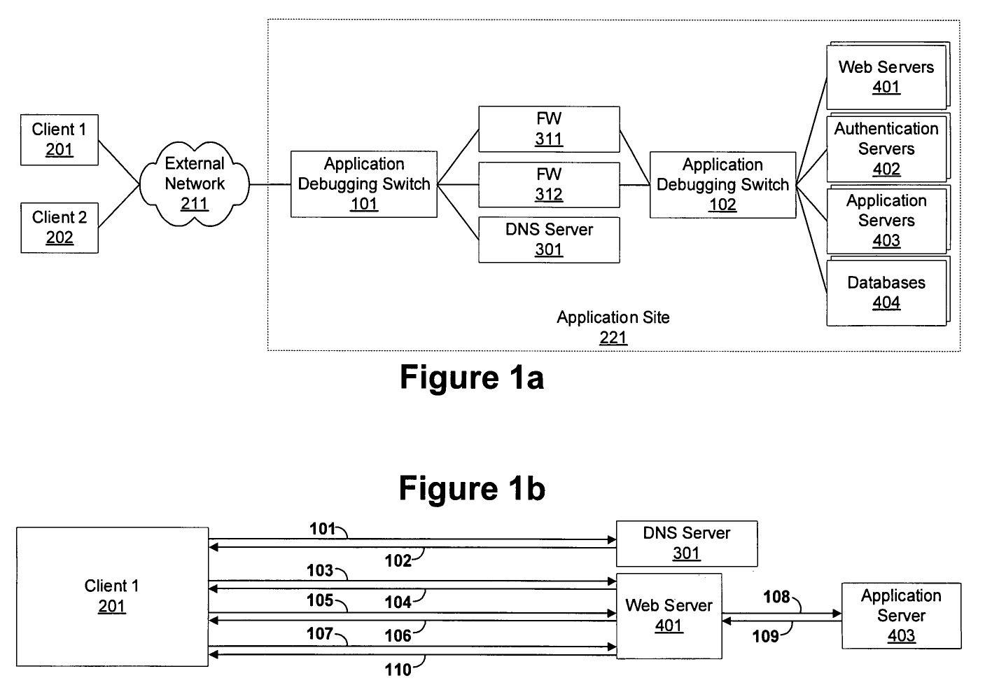

FIG. 1A describes an application environment according to the present invention. Clients 201 and 202 connect through external network 211 to application site 221. Application site 221 includes DNS server 301, security gateways 311 and 312, Web server cluster 401, authentication server cluster 402, application server cluster 403, and database 404. Two application debugging switches are located in application site 221. Application debugging switch 101 is located in the access point from external network 211 to application site 221 to manage and monitor all the traffic coming to the site from the application users. Application debugging switch 102 is located between the security gateways and the server clusters to manage and monitor the actual application traffic and the transactions between all the server clusters.

FIG. 1B describes an example of a possible traffic flow in an Application Site. Client 201 wants to make a web transaction of the application www.site.com. To perform the transaction the process involves multiple servers in the application site and multiple sequences of communication between client 201 and the servers in the site. Obviously, failures and slow performance can occur on every step of the transaction. First, client 201 sends DNS request 101 to DNS server 301 asking the resolution of the domain name www.site.com to an IP address. DNS server 301 responds with DNS response 102 specifying the IP address of web server 401. Second, client 201 opens a TCP connection with web server 401. Client 301 sends TCP connection request 103 to web server 401 and receives an acknowledgement 104 from the web server 401 for establishing a TCP connection between the client and server. Third, client 201 sends information request 105 to web server 401 and receives information response 106. Fourth, client 201 sends transaction request 107 to web server 401. Web server 401 performs transaction request 108 with application server 403 and receives transaction response 109. Then, web server 401 sends a transaction response 110 to client 201.

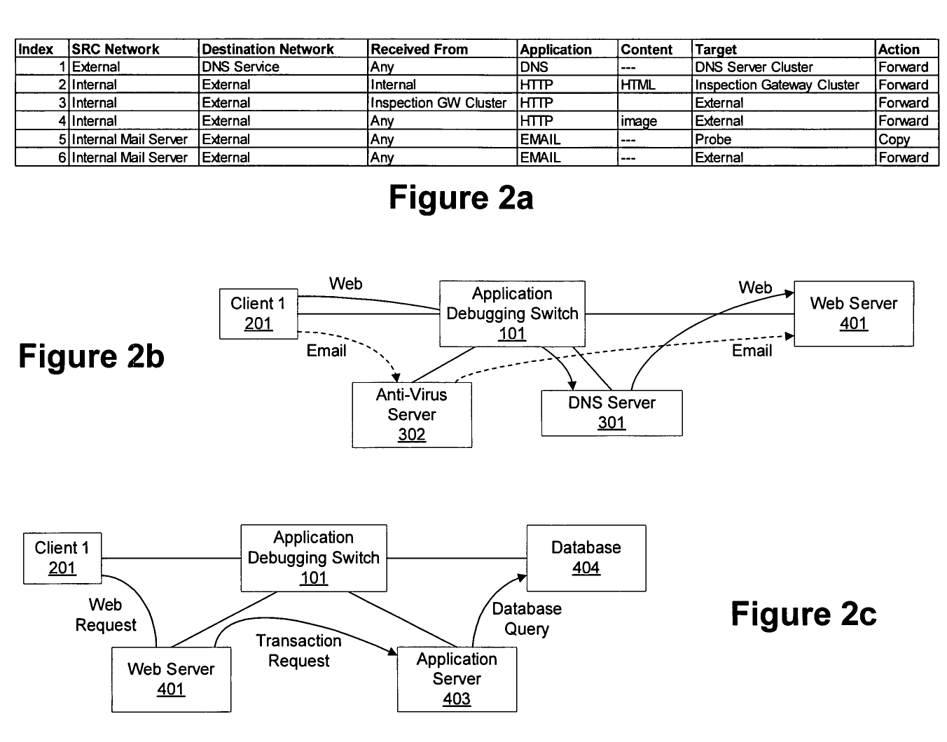

FIG. 2A describes a set of forwarding policies in the application debugging switch. The forwarding policies state the forwarding destination of traffic received by the application debugging switch. Each policy defines several parameters that classify the traffic, and the action to perform when such traffic arrives. Traffic can be classified by multiple parameters like what is the source and destination network addresses of the traffic, which local device sent the traffic, through which physical interface did the traffic arrive, which application traffic is it and which actual content is inside the traffic. This is a combination of definitions in networking layers 1 through 7 that defines the traffic. An action to perform consists of a target where traffic should be sent and the forwarding manner—a regular forwarding of traffic or copying the traffic while forwarding it to another target.

FIG. 2A presents a few example policies in the Forwarding policy table, and shows only part of the fields in the table. The policy with index number 1 relates to traffic that belongs to DNS application, coming from the external network and destined to the DNS service address. The application debug switch forwards the traffic matching policy 1 to the DNS server cluster. The policies with indices number 2 to 4 relate to traffic that belongs to the HTTP application, going from the internal network to the external network. Such traffic that contains HTML file requests coming from the internal network is sent to the Inspection gateway cluster according to policy number 2. When coming back from the Inspection gateways the traffic continues to the external network according to policy number 3. HTTP traffic that includes image file requests doesn't require inspection and when it comes from the internal network it continues forward directly to the external network according to policy number 4. The policies with indices number 5 and 6 relate to e-mail traffic, going from the internal mail server to the external network. This traffic is first copied to a probe that collects all the e-mails for further analysis according to policy number 5. Simultaneously, the traffic is forwarded to the external network.

FIG. 2B describes the actual forwarding of traffic between client 201 and server 401. Application debugging switch 101 receives HTTP traffic coming from client 201 and forwards it to cache server 301. If cache server 301 does not have the information it sends the request back to application debugging switch 101 that forwards the traffic towards server 401. Application debugging switch 101 further receives e-mail traffic from client 201 and forwards it to anti-virus server 302 for inspection. Anti-virus 302 sends the traffic forwards after inspection and application debugging switch 101 now forwards the verified content to server 401. This flow is bi-directional such that all the request and response packets go the same way and cache server 301 or anti-virus server 302 can inspect all the traffic going between client 201 and server 401.

FIG. 2C describes another example for actual traffic forwarding. Application debugging switch 101 is set between client 201, Web server 401, application server 403, and database 404. When a request comes from client 201 to application debugging switch 101, the switch forwards the request to Web server 401. Web server 401 then generates a transaction request. This transaction request reaches application debugging switch 101, which forwards the transaction request to application server 403. Application server 403 sends a DB query for information. The query reaches the application debugging switch 101, which forwards the query to database 404. The responses for each request or query are flowing the opposite way through application debugging switch 101.

FIG. 2D describes another example for actual forwarding of traffic between client 201 and server 401. E-mail traffic from client 201 reaches application debugging switch 101. Application debugging switch 101 sends a copy of the traffic to recording system 303 while forwarding the traffic to server 401. When the response arrives from server 401, application debugging switch 101 sends a copy of the response to recording system 303, while forwarding the response to client 201.

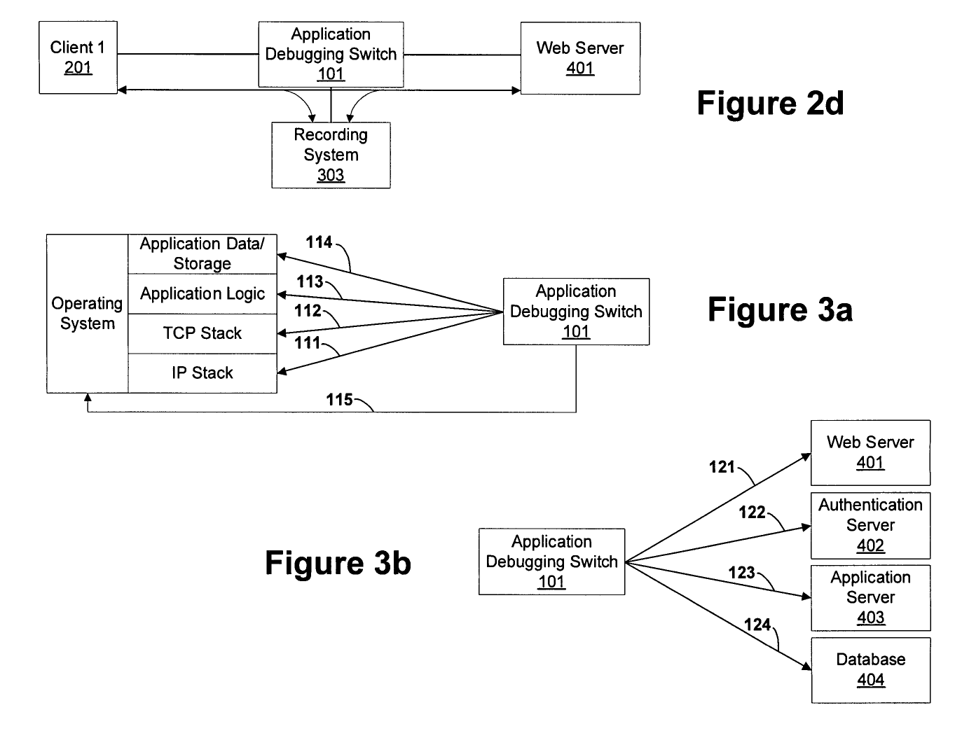

FIG. 3A describes the health checking aspect of the present invention. Server 411 runs an application that uses operating system resources, networking resources, and storage resources. Each of these resources may fail or suffer from low performance. Application debugging switch 101 performs multiple checks in order to verify the availability of all the resources. Check 111 is targeted at the IP stack and networking resources of server 411. As an example for the check, application debugging switch 101 sends an ICMP echo request to the IP address of server 411 and waits for an ICMP echo reply. As another example for the check, application debugging switch 101 sends an ARP request to server 411 and waits for an ARP reply. Check 112 is targeted at the TCP stack and networking resources of server 411. As an example for the check, application debugging switch 101 sends a TCP SYN request to server 411 and waits for a SYN ACK response, before terminating the TCP connection. Check 113 is targeted at the Application logic of server 411. As and example for the check, application debugging switch 101 opens a connection and sends an application status request waiting for a status reply. This status request is specific for the application. Each application can have a different check that is configurable by an administrator of application debugging switch 101. As other examples for the check, application debugging switch 101 sends a login request, a logout request, a request for the number of connections or any other request that the application can offer a response for. Check 114 is targeted at application data and the storage resources of server 411. As an example for the check, application debugging switch 101 sends an information request such that the application has to get the information from its storage or database, waiting for a reply that proves the operation of the application and storage. Check 115 is targeted at the operating system and CPU of server 411. As an example for the check, application debugging switch 101 sends a request for determining the current CPU utilization of server 411 waiting for a response to show whether the CPU utilization is over a threshold and how high it is relative to other servers' utilization. As other examples for the check, application debugging switch 101 sends a request to determine the available disk space, the available RAM, or any other operating system parameters. Each of the checks verifies that the resources are available. The check also follows the response time between the request and the reply and provides an indication of slow performance and bottlenecks of each of the resources. For example, there can be an indication of a slow application performance while the TCP/IP stack functions well. This points to a problem in the application logic level.

FIG. 3B describes the health checking of a path. A web application is running by Web server 401, authentication server 402, application server 403 and database 404. Application debugging switch 101 checks the health of all these servers to verify the health of the whole application path. Check 121 targets the Web server 401. As an example for the check, application debugging switch 101 sends a web request to Web server 401 and waits for a response. As another example, applications debugging switch 101 sends an ICMP request or opens a TCP connection with Web server 401 and waits for a response. Check 122 targets authentication server 402. As an example for the check, application debugging switch 101 sends an authentication request to authentication server 402 and waits for a response. Check 123 targets application server 403. As an example for the check, application debugging switch 101 sends a request for a TCP connection to application server 403 and waits for a response. Check 124 targets database 404. As an example for the check, application debugging switch 101 sends an ICMP request to database 404 and waits for a response. Application debugging switch 101 uses a different check method for each server in the application path. It uses any number of checks as required and according to Boolean conditions of the results determines the health of the path. For each server, the application debugging switch 101 uses any of the health checks mentioned in the description of FIG. 3A.

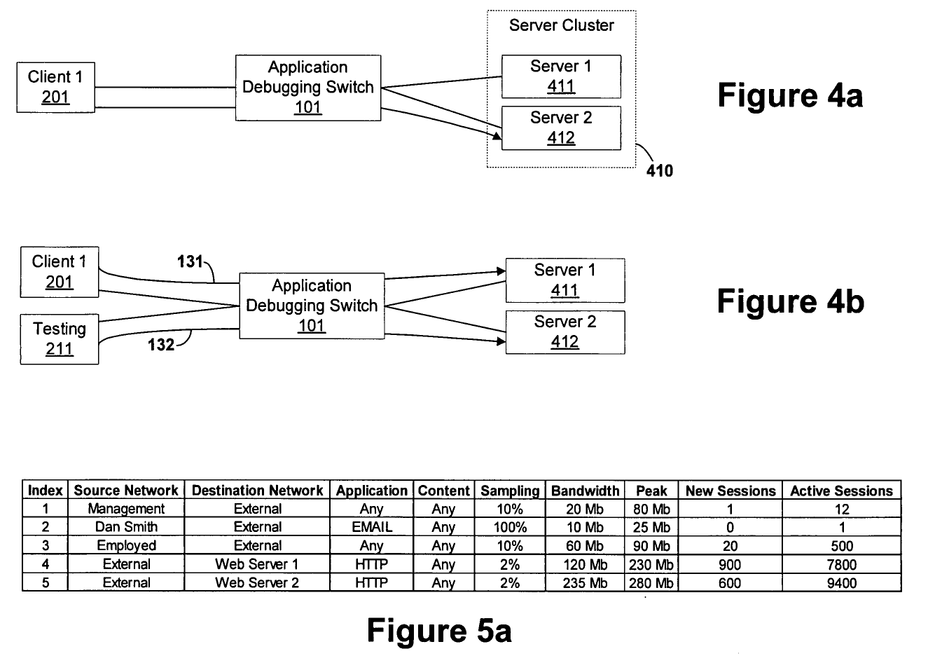

FIG. 4A describes a load balancing decision. Application debugging switch 101 is placed in front of server cluster 410 that includes server 411 and server 412. A request from client 201 reaches application debugging switch 101 that determines according to the forwarding rules that the request should go to one of the servers in server cluster 410. In order to select the server from the multiple servers in the cluster, application debugging switch 101 takes multiple parameters to make a decision. Parameters for a load balancing decision are subset of the current user load on the resource; the current traffic load on the resource; the current availability/health of the resource; the administrative operation status of the resource; a weight reflecting the resource capacity; the current responsiveness of the resource; the current packet loss of the resource; the current error rate for transaction over the resource.

FIG. 4B describes a debugging system according to the present invention. Application debugging switch 101 serves requests coming from regular user 201 and from testing equipment/testing user 211. Server 411 is dedicated to serve regular traffic and server 412 is dedicated to serve testing traffic. Both servers may also be part of a group or cluster of servers. Application debugging switch 101 classifies request 131 coming from regular user 211 as a regular request and forwards it to server 411. Application debugging switch 101 classifies request 132 coming from testing user 211 as a testing request and forwards it to server 412. A testing equipment/testing user can be a user that generates simulated traffic for the benefit of monitoring performance. A testing user can also be a regular user that requests investigation of its service quality, such that the system follows the traffic between this user and the servers.

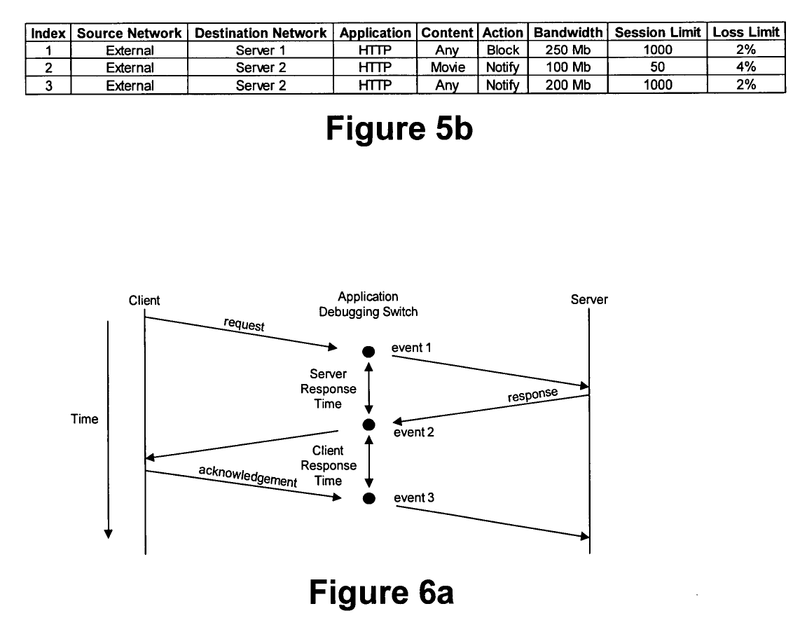

FIG. 5A describes a policy statistic table according to the present invention. The table allows classification of traffic by parameters in all communication layers. The drawing shows a selection of the source network; destination network; application; and content, but the classification is not limited to these fields only. Any parameter in a packet may be set as a classifier of traffic. To retrieve statistics of the traffic the application debugging switch can sample only part of the traffic. As the sample rate is higher the statistics are more accurate but this is negligible in large amounts of traffic. Each policy uses a different sampling rate to fit the amount of traffic and the accuracy of the reporting. For each class the table shows the amount of bandwidth used for the class; the peak amount of bandwidth that the class utilized; the number of new sessions initiated in the last period; the number of active ongoing sessions. Other statistics like peak values for a period or total values may be shown in the table.

The policy statistic entry indexed 1 shows traffic coming from the management network going to the external network with regards to all the applications and contents. It uses a sampling rate of 10%. This traffic consumed 20 Mb in the last period compared to a peak value of 80 Mb earlier. A single session initiated in the last period and overall there are 12 sessions active.

The policy statistic entry indexed 2 shows e-mail traffic coming from a single person named Dan Smith going to the external network. It uses a sampling rate of 100% so that no transaction is missed. This traffic consumed 10 Mb in the last period compared to a peak value of 25 Mb earlier. No session initiated in the last period and overall there is a single session active from previous activity.

The policy statistic entry indexed 3 shows traffic coming from the employees network going to the external network with regards to all the applications and contents. It uses a sampling rate of 10%. This traffic consumed 60 Mb in the last period compared to a peak value of 90 Mb earlier. 20 sessions initiated in the last period and overall there are 500 sessions active.

The policy statistic entry indexed 4 shows traffic coming from the external network going to a web server number 1. It uses a sampling rate of 2% as the amounts of traffic are very big. This policy only relates to HTTP traffic. This traffic consumed 120 Mb in the last period compared to a peak value of 230 Mb earlier. 900 sessions initiated in the last period and overall there are 7800 sessions active.

The policy statistic entry indexed 5 shows traffic coming from the external network going to a web server number 2. It uses a sampling rate of 2% as well. This policy only relates to HTTP traffic. This traffic consumed 235 Mb in the last period compared to a peak value of 280 Mb earlier. 600 sessions initiated in the last period and overall there are 9400 sessions active.

FIG. 5B describes a policy threshold table according to the present invention. The application debugging switch monitors the amount of traffic that goes through any policy in order to guarantee the quality of service for all applications. The switch either provides notification when thresholds are crossed or blocks the traffic over the thresholds. The policy threshold table offers policy classifiers similar to that of the policy statistic table. It offers thresholds on multiple parameters including the amount of bandwidth, the number of active sessions or the amount of packet loss in the network. The switch either blocks traffic or just notifies according to the requested action.

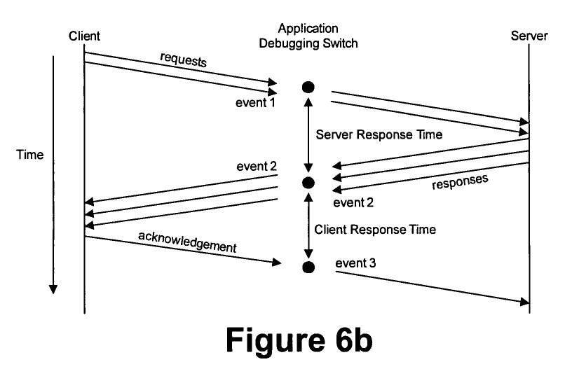

FIG. 6A describes a general measurement of response time. The application debugging switch monitors the traffic going between a client and a server. When a request arrives from a client the application debugging switch keeps track of the timing of this first event. When a response comes back from a server the application debugging switch keeps the timing of this second event, calculates the time difference between the first event and this event and logs the server response time of the micro-transaction. When the client acknowledges the response the application debugging switch keeps the timing of this third event, calculates the time difference between the second event and this event and logs the client response time of the micro-transaction. The application debugging switch handles multiple requests and responses in parallel. Measuring the response time is operated either on each micro-transaction or by sampling part of the transactions so that performance is not affected.

For each application there is a different indication for a request, a response or an acknowledgement. Yet, every application traffic can map to the general model of response time measurement. TCP applications start with a three-way handshake between a client and a server such that a client sends a TCP SYN packet, the server responds with a TCP SYN/ACK packet and the client acknowledges with a TCP ACK packet. For HTTP applications, a client sends an HTTP request message and the server responds with an HTTP reply over the same TCP connection. For DNS applications, the client send a DNS query that carries a transaction ID and the DNS server responds with a DNS response with the same transaction ID. For SSL transactions there is a longer sequence of messages going between a client and a server. The application debugging switch measures the time difference between the “Client Hello” message of the client and the “Finished” message of the server for the SSL handshake response time. It also measures the time difference between the first client request after the handshake is complete and the following server response for the SSL application response time. For IMAP applications the client sends a TCP ACK for the initial session handshake and the server supplies a status message. Later the client sends a login command and the server responds to approve/disapprove it. For POP applications the client sends a TCP ACK for the initial session handshake and the Server supplies a status message. Later the client sends a password command and the server responds to approve/disapprove it. For SMTP applications the client sends a TCP ACK for the initial session handshake and the server supplies a status message. Later, the client sends a HELO/EHLO command and the server responds to approve/disapprove it. For FTP applications, the client sends a USER command and the server responds to it. For RTSP applications, the client sends a SETUP command and the server responds to it. For SIP applications the client sends an INVITE command having a “Call-ID” and the server responds with a status message that has the same “Call-ID”. For H.323 applications the client sends an admission request (ARQ) message and the server responds with a confirmation (ACF) or rejection (ARJ) of the connection. For NFS applications the client sends an RPC call with a transaction ID and the server responds with the same transaction ID. For NNTP applications the client sends a LIST commend and the server responds with a return code and data. For LDAP applications the client sends a “search request” message and the server responds with a “search response” message. For RADIUS applications the client sends an “access request” message and the server responds with an “access accept” message. Other applications have similar sequences, and the application debugging switch simply monitors the request coming from the client and the following response coming from the server.

FIG. 6B describes a general measurement of response time for transactions with multiple packets. A request, a response or an acknowledgement can carry large amounts of data and are not limited to a single packet. When a first request packet arrives from a client the application debugging switch keeps track of the timing of this first event. When a second request packet arrives with the continuation of the request data the application debugging switch resets the timing of the first event. When a first response packet comes back from a server the application debugging switch keeps the timing of this second event, calculates the time difference between the first event and this event and logs the server response time of the micro-transaction. When a second and third response packets arrive with the continuation of the response data, the application debugging switch resets the timing of the second event. When the client acknowledges the response or issues another request (Note: It should be noted that although the specification and examples used describe a client acknowledgement, another client request can serve as the client acknowledgement signal), the application debugging switch keeps the timing of this third event, calculates the time difference between the second event and this event and logs the client response time of the micro-transaction.

FIG. 6C describes an HTTP transaction and the various response time measurements that take part in that transaction. To communicate with an HTTP server, a Client first resolves the server name (e.g. www.microsoft.com) to an IP address through a DNS request. The application debugging switch receives a DNS query from a client and a DNS response from the DNS server and calculates the DNS response time (1). Then the client opens a TCP connection with the HTTP server and the application debugging switch receives the TCP handshake messages to calculate the TCP response time of the server (2) and the client (3). Then, the client finally sends a HTTP request and the HTTP server responds. The application debugging switch receives these messages to calculate the HTTP response time (4). All of the response times are meaningful to the measurement of the user's experience for an HTTP application. Users complain when the DNS server responds slowly, when the TCP stack responds slowly, when the HTTP server responds slowly or when the network that connects the client and server is slow. An HTTP application can also combine further steps like communication between a HTTP server and an authentication server, communication between a HTTP server and a database or communication between a HTTP server and an Application server. The application debugging switch measures the response time of each of these steps to supply a complete view of the application performance and functionality to the operator of the application. Other applications like FTP, SIP, RTSP and more are also using multiple steps like a DNS resolution, a TCP connection and then application communication. For every application the application debugging switch can provide a full set of measurements to the response times of each phase, therefore letting the operator zoom in easily for the source of a slow response time for the end user.

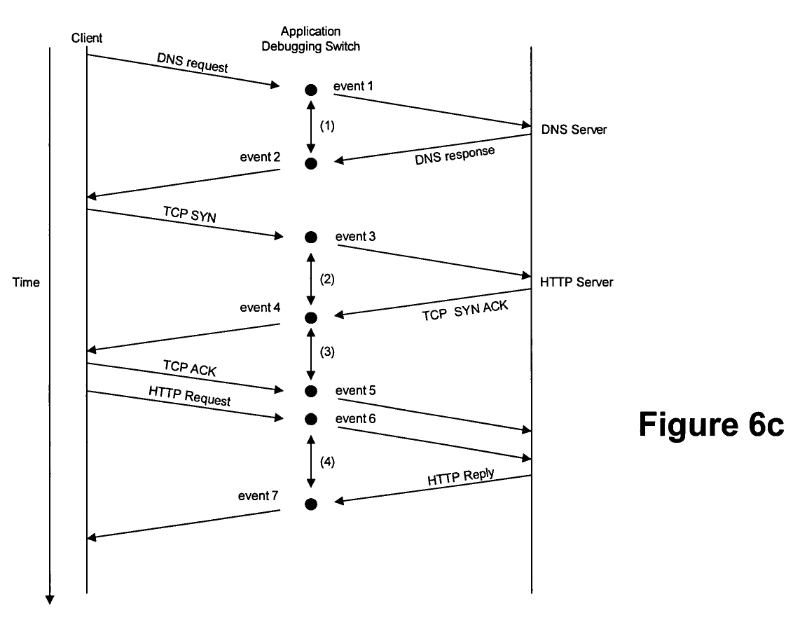

FIG. 7A describes an indication for packet loss. The application debugging switch detects packet loss problems when it recognizes retransmissions of previous packets. Using the TCP protocol it is easy to recognize a retransmitted packet as two packets of a TCP connection shouldn't have the same TCP sequence numbers unless it's a retransmission. Other protocols have different indications to recognize retransmissions like a message ID or an application sequence number. The application debugging switch receives a first packet from a first host and maintains the parameters of this packet in memory. If the first host doesn't receive any acknowledgement from the second host it will retransmit the packet. The application debugging switch recognizes that the packet is a retransmission and indicates a packet loss in the network. The application debugging switch can further verify that indeed no acknowledgement arrived for the packet and conclude that the loss of the packet occurred somewhere on the way to the second host.

FIG. 7B describes a second indication for packet loss. The application debugging switch recognizes the retransmission of a packet, but this time also notices that an acknowledgement did come from the second host. Therefore, the application debugging switch concludes that the packet loss occurred somewhere on the way to the first host.

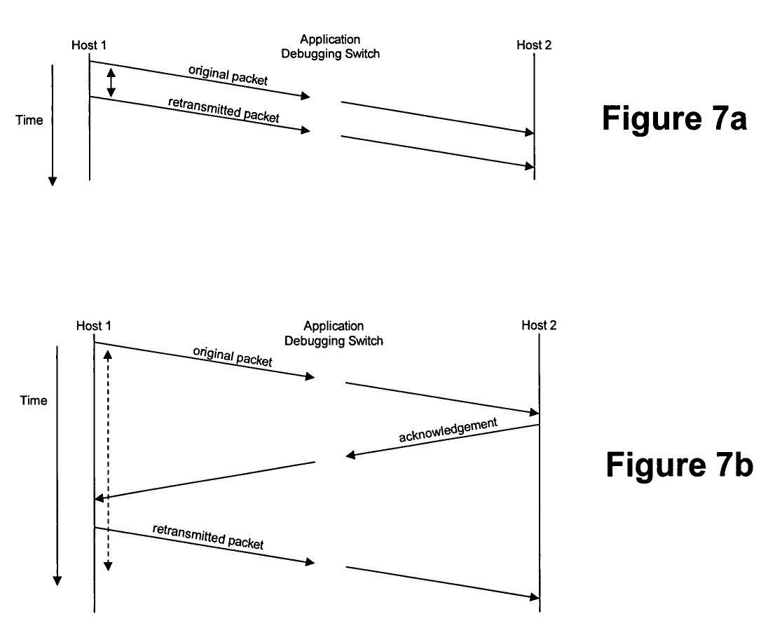

FIG. 8A describes a successful TCP transaction. The application debugging switch receives a TCP SYN packet from a host to a server, and then receives a TCP SYN/ACK response from the Server to that host. Similar to TCP, other applications also have a successful sequence of messages that indicates the success of a transaction. The application debugging switch follows on the messages that pass between the hosts on the network and can recognize that transactions are successful. A successful DNS transaction starts with a DNS query from the client and a DNS response from the server with no error condition. A successful HTTP transaction starts with an HTTP request from the client and an HTTP response from the server that has a successful HTTP return code. Return code 200 is always an indication of success as well as other return codes like 3XX and more, depending on the application logic. A successful FTP transaction starts with an FTP command from the client and a FTP reply from the server that has a successful return code. 1XX, 2XX and 3XX are considered positive, and specific FTP application logic may determine different than this default. In a similar manner, each application can have its own logic and the application debugging switch can recognize that a transaction is successful. The application debugging switch can also use the opposite logic and recognize negative return codes of applications. In this case a successful transaction is a transaction that the response doesn't carry a negative return code.

FIG. 8B describes an unsuccessful TCP transaction. Two examples are given. In the first sequence of packets, the application debugging switch receives a TCP SYN packet from a client to a server and then a TCP RST packet from the server to the client stating the server's refusal for opening a TCP connection with the client. In the second sequence of packets the application debugging switch receives a TCP SYN packet from a client to a server, but never sees a response from the server. In both cases the TCP transaction has failed. In general, every application offers two such models for unsuccessful transactions. The first is when a server sends a negative response to a client's request and the second is when the server doesn't respond to the client's request within a certain period of time. Similar to the recognition of the successful return codes of the various applications, the application debugging switch recognizes unsuccessful return codes (either stated to be unsuccessful or failed to be successful).

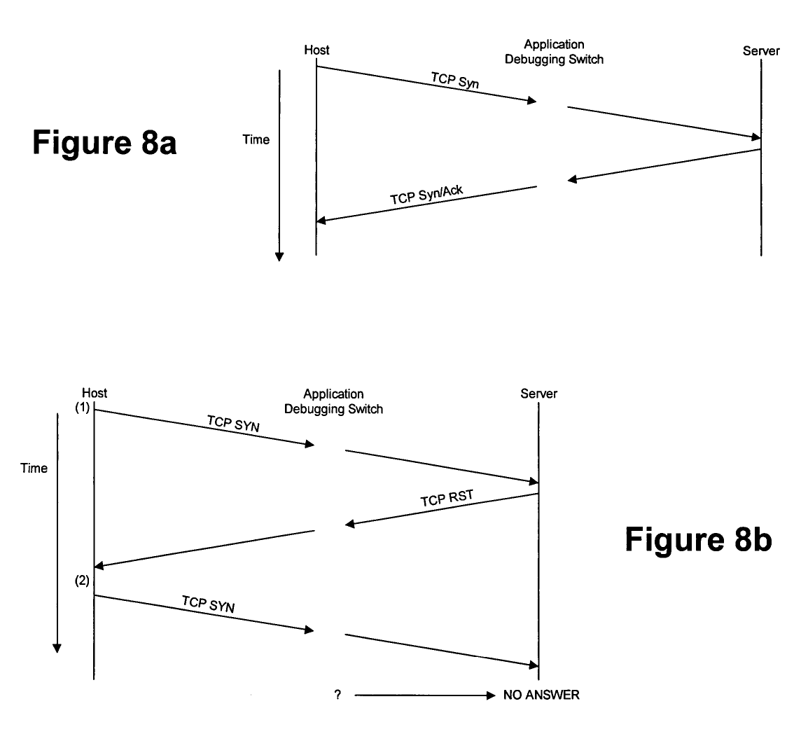

FIG. 9A describes the topology for using the application debugging switch for logging the network activity. Traffic of a session between client 1 and a server reaches the application debugging switch. In the same time, traffic of another session between client 2 and the same server reaches the application debugging switch as well. The application debugging switch follows up on the progress of the sessions to get all the information regarding the two endpoints, the communication data and the performance statistics of the session. The application debugging switch records the information of each session separately and also combines average statistics data according to pre-configured policies. The application debugging switch reports the records and the policy statistics to a logging server or multiple logging servers. In case of multiple logging servers the application debugging switch reports to each server the part of the data that a server registers to get. The application debugging switch can be an active switch on the path between a client and a server and take part in the data forwarding, or it can just receive a copy of the traffic from a network switch.

FIG. 9B describes a policy logging report from the application debugging switch to a policy logging server. The report includes information about two policies. The policy with the index 1 has an average response time of 120 milliseconds and a peak response time of 180 milliseconds. This first policy also has an average ratio of 0% failed transactions and a peak ratio of 12% failed transactions per second. This first policy also has an average ratio of 0% packet loss and a peak ratio of 3% packet loss per second. The policy with the index 2 has an average response time of 50 milliseconds and a peak response time of 110 milliseconds. This second policy also has an average ratio of 0% failed transactions and a peak ratio of 5% failed transactions per second. It also has an average ratio of 0% packet loss and a peak ratio of 1% packet loss per second.

FIG. 9C describes a record logging report for two sessions. This is part of the information that the application debugging switch sends to the debugging center. The first record holds the details of a session between source IP 1.1.1.1 and destination IP 2.1.1.1 through HTTP application receiving an Image file. The session started at 08:07:11 and ended at 08:07:26 passing 7 KB. The response time was 160 milliseconds, 1% of the packets were lost and there was no failure. The second record holds the details of a session between Source IP 1.1.1.2 and Destination IP 2.1.1.2 through E-mail application receiving a text file. The session started at 08:07:20 and ended at 08:08:12 passing 415 MB. The response time was 40 milliseconds, 0% of the packets were lost and the session ended by reset. The debugging center analyzes these records and offers detailed reports on a user level and transaction level. The debugging center also analyzes trends in the user experience for different applications in different times of the day and different network locations.

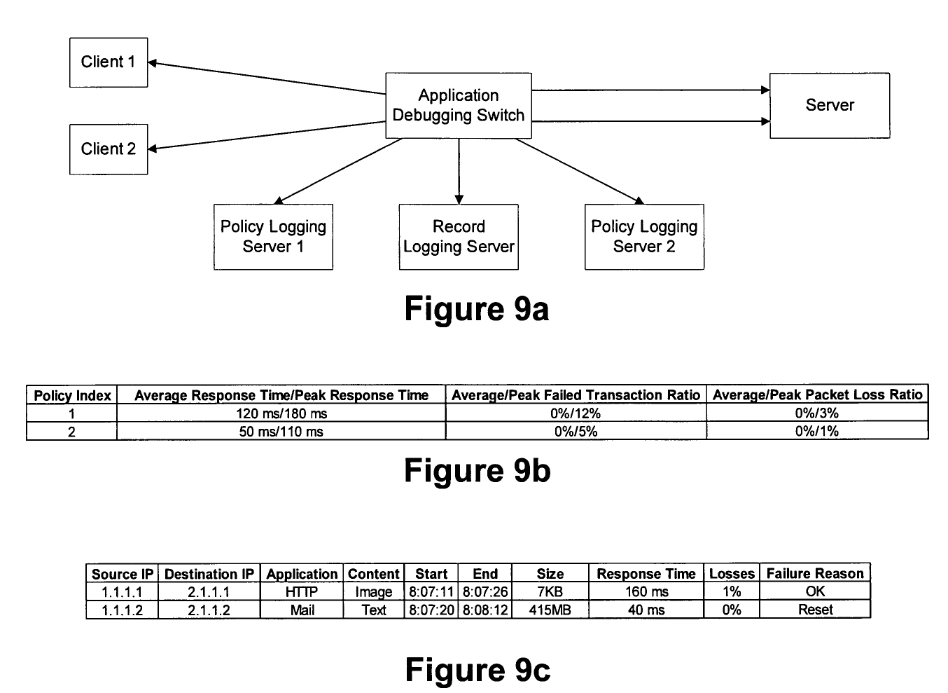

FIG. 10 describes a configuration that uses multiple application debugging switches on the path between a client and a server. Placed in different places on the path, the two application debugging switches report different statistics. Application debugging switch 1 is closer to the client and reports a longer response time then application debugging switch that is closer to the server. The difference in the response time is a result of the network latency between the switches. Analyzing and comparing the reports from both switches it is possible to detect the segments of the network where packet loss occurred—whether on the server side, on the client side or somewhere between the switches. It is also possible to detect the network segment where the network latency is large. The more application debugging switches that are placed on the network the more granular statistics can be reviewed in the debugging center. Using many application debugging switches, the debugging center sets different classification policies on each of the application debugging switches and analyzes the user experience of different users, applications or contents at any time. When the application debugging switch handles multiple passes of the same transaction through it as described in drawings 2B/2C, the switch reports multiple response times. In this case, the debugging center analyzes the delays of the various devices or applications that the application debugging switch manages.

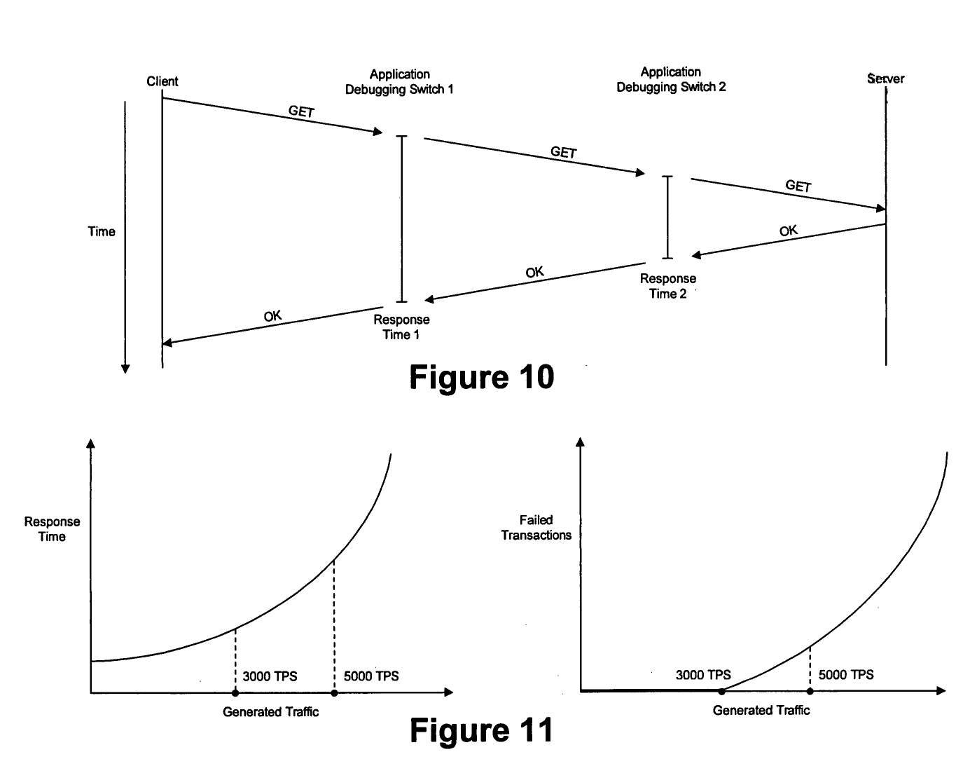

FIG. 11 describes a combination of operating the application debugging switch and a traffic generation machine. The progressing response time graph shows the increase in application response time as the generated traffic increases. The graph teaches that the response time stays low when serving up to 3000 transactions per second. When the traffic increase further until 5000 transactions per second the response time grows faster and faster and over 5000 transactions per second cause the application not to function. A second graph shows similar data about failed transactions. The application handles up to 3000 transactions per second without failures. When the traffic increases to 5000 transactions per second the application experiences some failures. Increasing the traffic further than 5000 transaction cause to many failures of the transactions.

Additionally, the present invention provides for an article of manufacture comprising computer readable program code contained within implementing one or more modules to debug application performance over a network. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

### CONCLUSION

A system and method has been shown in the above embodiments for debugging application performance over a network. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network programming.

1. A method to monitor response times associated with client(s) and server(s) located in a network, said method implemented in an application debugging switch among a plurality of said application debugging switches dispersed over said network, said method comprising the steps of:
receiving a request from a client intended for a server and identifying and storing a timestamp t1 when said request is received;
forwarding said request to said server;
receiving a response from said server and identifying and storing timestamp t2 when said response is received, and
calculating a server response time as a difference between t2 and t1,
wherein said calculated server response time identifies indicates network and application responsiveness.

2. A method to monitor response times associated with client(s) and server(s) located in a network, as per claim 1, wherein said method further comprises the steps of:
forwarding said response to said client and storing timestamp t3 when said response is forwarded;
receiving an acknowledgement from said client, storing timestamp t4 when said response is received, and
calculating a client response time as a difference between t4 and t3.

3. A method to monitor response time associated with client(s) and server(s) located in a network, as per claim 2, wherein said acknowledgement from said client is a request from said client.

4. A method to monitor response times associated with client(s) and server(s) located in a network, as per claim 1, wherein said network is any of the following: local area network (LAN), wide area network (WAN), or the Internet.

5. A method to monitor response times associated with client(s) and server(s) located in a network, as per claim 1, wherein said request is an IP request.

6. A method to monitor response times associated with client(s) and server(s) located in a network, as per claim 1, wherein said request is based on any of the following protocols: TCP/IP, HTTP, DNS, SSL, IMAP, POP3, SMTP, FTP, RTSP, SIP, H.323, NFS, NNTP, LDAP, or RADIUS.

7. A method to monitor response times associated with client(s) and server(s) located in a network, as per claim 1, wherein said server is part of a plurality of servers in a cluster and said application debugging switch uses load balancing decisions to select a server in said cluster for forwarding communication from said client.

8. A method to monitor response times associated with client(s) and server(s) located in a network, as per claim 7, wherein said load balancing decision is based on said server response time of each server in said cluster

9. A method to monitor response times associated with client(s) and server(s) located in a network, as per claim 7, wherein said load balancing decision is based on any of the following: current user load of each server in said cluster, current traffic load of each server in said cluster, current availability and health of each server in said cluster, administrative operation status of each server in said cluster, a weight reflecting a resource capacity of each server in said cluster, responsiveness of each server in said cluster, packet loss of each server in said cluster, or error rate of transactions in each server in said cluster.

10. A method to monitor response times associated with client(s) and server(s) located in a network, as per claim 1, wherein said application debugging switch maintains a policy statistic table defining classes and comprising any of, or a combination of, the corresponding bandwidth and sampling rate of traffic to be monitored.

11. A method to monitor response times associated with client(s) and server(s) located in a network, as per claim 1, wherein said application debugging switch maintains a policy statistic table defining classes of traffic to be monitored.

12. A method to monitor response times associated with client(s) and server(s) located in a network, as per claim 11, wherein said policy statistic table further comprises any of, or a combination of, the following parameters: number of new sessions initiated in a prior period, number of active ongoing sessions, amount of bandwidth consumed in a prior period or peak bandwidth value for a predefined prior period.

13. A method to monitor response times associated with client(s) and server(s) located in a network, as per claim 1, wherein said application debugging switch further comprises a policy threshold table maintaining one or more of the following thresholds: amount of bandwidth, number of active sessions, number of new sessions per period or amount of packet loss, with said application debugging switch either terminates traffic or notifies an external entity when said thresholds are breached.

14. A method to monitor response times associated with client(s) and server(s) located in a network, as per claim 1, wherein said application debugging switch further comprises a policy threshold table maintaining a server response time threshold, with said application debugging switch either terminates traffic or notifies an external entity when said threshold is breached.

15. A method implemented in an application debugging switch to identify bottlenecks associated with a server based on monitoring network and application response times associated with a plurality of clients and said server, said method comprising the steps of:
receiving a plurality of requests from said plurality of clients to said server;
forwarding said plurality of requests to said server and monitoring network and application response times, said plurality of requests targeting a combination of any of the following: a communication protocol stack supported by said server, application logic of said server, storage resources of said server, operating system resources of said server, or CPU resources of said server;
storing timestamps associated with said plurality of transmitted requests;
receiving a plurality of responses from said server, identifying and storing a timestamp for each received response;
calculating server response time for each received response as a difference between timestamp of each received response and a timestamp associated with a corresponding transmitted request; and
identifying network and application bottlenecks associated with said server based on said calculated server response times.

16. The method per claim 15, wherein said method further comprises the steps of:
forwarding each of said plurality of responses to a corresponding client and storing a timestamp when said response is forwarded;
receiving an acknowledgement from said client and storing a timestamp when said response is received;
calculating client response time for each forwarded response as a difference between the timestamp of each forwarded response and a timestamp associated with a corresponding acknowledgement, and
identifying network bottlenecks associated with said client based on said calculated client response times.

17. The method per claim 15, wherein said network is any of the following: local area network (LAN), wide area network (WAN), or the Internet.

18. The method per claim 15, wherein said request is based on any of the following protocols: TCP/IP, HTTP, DNS, SSL, IMAP, POP3, SMTP, FTP, RTSP, SIP, H.323, NFS, NNTP, LDAP, or RADIUS.

19. The method per claim 15, wherein said request targeting a communication protocol is an IP request.

20. A networking system comprising:
a plurality of application debugging switches dispersed throughout a network, each application debugging switch:
receiving a request from a client to a server;
forwarding said request to said server and storing timestamp t1 when said response is forwarded;
receiving a response from said server and storing timestamp t2 when said response is received, and
calculating a server response time as a difference between t2 and t1, and
a debugging center collecting response time information from said plurality of application debugging switches and mapping application and/or network responsiveness.

21. A networking system, as per claim 20, wherein said request targeting any of, or a combination of, any of the following: a communication protocol stack supported by said server, application logic of said server, storage resources of said server, operating system resources of said server, or CPU resources of said server;

22. A networking system, as per claim 20, wherein said network is any of the following: local area network (LAN), wide area network (WAN), or the Internet.

23. A networking system, as per claim 20, wherein said application debugging switch further forwarding said response to said client and storing timestamp t3 when said response is forwarded, receiving an acknowledgement from said client, storing timestamp t4 when said response is received by said client, and calculating a client response time as a difference between t4 and t3.

24. A networking system comprising:
at least one application debugging switch facilitating communication between one or more clients and at least one application server and collecting statistics comprising network response times and application response times associated with said server;
at least one policy logging server maintaining one or more policies defining mathematical operations on collected statistics, wherein said at least one application debugging switch performs mathematical operations on said collected statistics according to a predefined policy in said policy logging server; and
wherein said collected statistics are used to map application and network responsiveness.

25. A networking system, as per claim 24, further comprising:
at least one record logging server receiving collected statistics operated on according to a predefined policy in said at least one policy logging server.

26. A networking system, as per claim 24, wherein said network is any of the following: local area network (LAN), wide area network (WAN), or the Internet.

27. A networking system, as per claim 24, wherein said at least one policy logging server maintains a policy logging report comprising any of the following entries: policy index, average response time/peak response time, average/peak failed transaction ratio, or average/peak packet loss ratio.

28. A networking system, as per claim 25, wherein said at least one record logging server comprises a record logging report comprising any of the following entries: source IP address, destination IP address, application type, content type, session start, session end, size of content, response time, losses, or reason of failure.

29. A method to monitor response times associated with client(s) and server(s) located in a network, said method implemented in at least two application debugging switches dispersed over said network, said method comprising the steps of:
receiving, at a first debugging switch, a request from a client intended for a server, said first application debugging switch:
identifying a timestamp t11 when it receives said request;
forwarding said request to said server;
receiving said forwarded request at a second debugging switch, said second debugging switch:
identifying a timestamp t21 when it receives said forwarded request;
forwarding said request to said server;
receiving a response from said server;
identifying a time stamp t22 when said response is received in said server, and forwarding said response to said client;
receiving said forwarded response at said first application debugging switch, said first application debugging switch:
identifying a timestamp t12 when said forwarded response is received;
forwarding said response to said client,
wherein a first response time RT1 is calculated in said first application debugging switch as the difference between response times t12 and t11 and a second response time RT2 is calculated at said second debugging switch as difference between response times t22 and t21, said response times identifying network and application responsiveness.

30. A method to monitor response times associated with client(s) and server(s) located in a network, as per claim 29, wherein said response times RT1 and RT2 are forwarded to a debugging center, said debugging center calculating a response time RT as the difference between RT1 and RT2, said difference RT identifying network bottlenecks between said first and second application debugging switch.

31. A networking system comprising:
a traffic generation machine generating network traffic;
a plurality of application debugging switches, wherein at least one application debugging switch:
receives a plurality of requests generated by said traffic generation machine intended for a server on said network, identifies and stores timestamps when said requests are received,
forwards said plurality of requests to said server;
receives a plurality of responses corresponding to said plurality of requests from said server,
identifies and stores timestamps when said responses are received and calculates response times as a difference between the time stamp when a request is received and the time stamp when a response is sent,
wherein said at least one application debugging switch in conjunction with the traffic generation machine increases the generated traffic intended for said server, calculates response time for said generated traffic, and identifies the amount of traffic when a failure threshold is reached.

32. A method implemented in an application debugging switch to monitor response times in phases for application transactions between a client to a plurality of servers, plurality of said application debugging switches dispersed over a network, said method comprising the steps of:
receiving a TCP connection request from said client and forwarding said TCP connection request to an application server at timestamp t1;
receiving a TCP acknowledgement message from said application server at timestamp t2, calculating a TCP response time as t2-t1, and forwarding said TCP acknowledgement message to said client;
receiving an application request from said client and forwarding said application request to said application server at timestamp t3;
receiving an application reply from said application server at timestamp t4, calculating an application response time as t4-t3, and forwarding said application reply to said client, and
wherein said application debugging switch measures response time of each phase in a transaction to identify responsiveness of each phase of said transaction.

33. The method per claim 32, said method further comprising the steps of:
receiving a DNS query from a DNS client and forwarding said DNS query to a DNS server at timestamp t5;
receiving a DNS response from said DNS server at timestamp t6, calculating a DNS server response time as t6-t5, and forwarding said DNS response to said DNS client.
